(19) United States
(12) Patent Application Publication
(10) Pub. No.: US 2020/0177524 A1
(43) Pub. Date: Jun. 4, 2020

(54) METHOD FOR SECURING COMPUTING SYSTEM NETWORKS THROUGH LOCKING OSI LAYERS 2 AND 3 ON INDIVIDUAL REMOTE COMPUTING DEVICES

(71) Applicant: Thomas James West, Blue Springs, MO (US)

(72) Inventor: Thomas James West, Blue Springs, MO (US)

(21) Appl. No.: 16/580,670

(22) Filed: Sep. 24, 2019

Related U.S. Application Data
(60) Provisional application No. 62/773,478, filed on Nov. 30, 2018.

(51) Int. Cl. H04L 12/931; H04L 12/46; H04L 12/773

(52) U.S. Cl. CPC H04L 49/351; H04L 45/60; H04L 12/4633

(57) ABSTRACT

A secure ethernet chassis and console port and a method of enabling the same is provided through turning off an ethernet switch and/or router console port (OSI layer 2 or layer 3). The present invention isolates and controls an inside network egress and an outside ingress of the physical console port. The present invention enables operator to turn off and secure the console port, allowing for chassis security as well as console port security for unattended devices as well as remote devices. The process also allows the reverse recovery of the port. The process works for devices with single or dual IP stacks. The turning off the console port completely isolates the inside network of the switch and prevents network intrusion or device corruption via the console port. It also prevents unauthorized configuration changes of the device.

### CROSS-REFERENCE TO RELATED APPLICATION

This application claims the benefit of priority of U.S. provisional application No. 62/773,478, filed 30 Nov. 2018, the contents of which are herein incorporated by reference.

### BACKGROUND OF THE INVENTION

The present invention relates to computer network security and, more particularly, to a method for securing computing system networks through locking OSI layers 2 and 3 on individual remote computing devices.

IT professionals utilize the Open Systems Interconnection (OSI) conceptual model to characterize a computing system. OSI layers 1 through 3 are the physical layer, the data link layer and the network link, respectively, while OSI layers 4-7 are transportation, session, presentation, and application layers, respectively. OSI layer 2 (data link) includes ethernet switches and OSI layer 3 (network link) includes the router, both of which are embodied in the ethernet device console port and the reset button.

Typically, a computing system network supports remote devices. Originally, these remote devices were designed for use in a data center or attended rooms with ITS personnel nearby. Today, these remote devices are ubiquitous outside the data center and frequently left unattended. Through these remote devices the underlying network infrastructure can be subject to unsolicited monitored, viral infections, malicious modifications, hacking, cyber-attacks and data theft. Typically, many of these intrusions comes through OSI layers 2 and 3.

As can be seen, there is a need for a method for securing computing system networks through locking OSI layers 2 and 3 on individual remote computing devices embodied in securement of console ports and reset button for isolated endpoint network devices. The present invention employs read radio buttons to completely lock such console ports and reset buttons, while still allowing network operations to quickly and easily check if a device is secure.

The locked console port and reset button makes the associated device immune to outside interference by eliminating unauthorized intrusion into OSI layers 2 and 3 as the reset button is rendered inert, making the associated device akin to a brick if stolen.

### SUMMARY OF THE INVENTION

In one aspect of the present invention, a method of providing security to a computer network coupled to a plurality of remote computing devices include providing a service control function for a remote computing device, the service control function configured to move an associated ethernet switch and/or an associated router console port to an off-locked condition.

In another aspect of the present invention, the method of providing security to a computer network coupled to a plurality of remote computing devices includes the following: instructing a central processor unit associated with the remote computing device, through machine code, to provide self-test interrupts for normal operations regardless of the off-locked condition; instructing, through machine code, a central processor unit associated with the remote computing device to provide a normal result for a Power On Self-Test regardless of the off-locked condition; instructing, through machine code, a central processor unit associated with the remote computing device to selectively moving the associated ethernet switch and/or the associated router console port to an on-unlocked condition, wherein the off-secured condition turns off a console serial port at a central processor unit associated with the remote computing device, and wherein the off-locked condition controls of an inside network egress and an outside ingress of the physical console port.

These and other features, aspects and advantages of the present invention will become better understood with reference to the following drawings, description and claims.

### BRIEF DESCRIPTION OF THE DRAWINGS

FIG. 1 is a diagrammatic view of an exemplary embodiment of the present invention explaining the coding process to securely lock a console part through the ethernet drive.

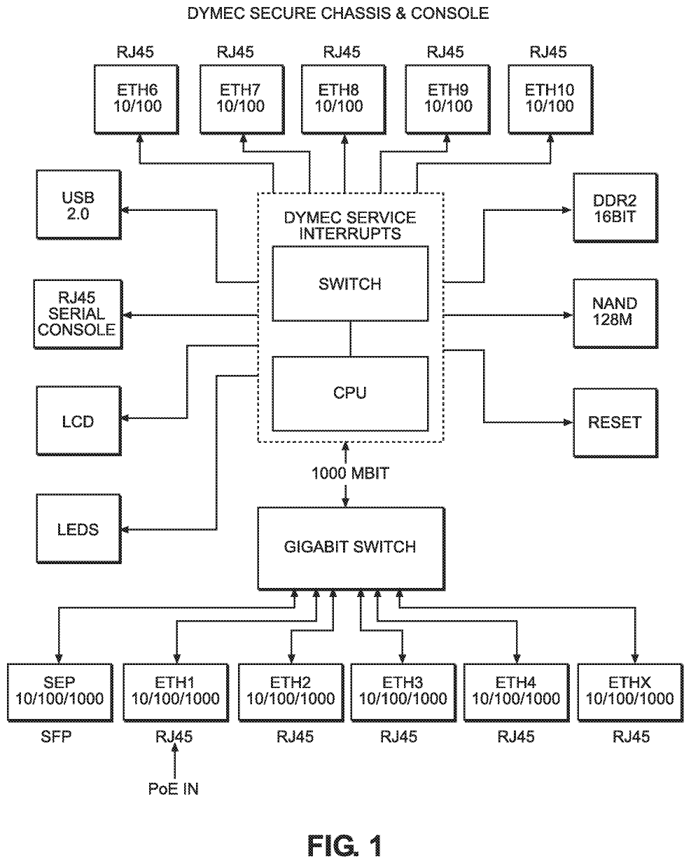

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a secure ethernet chassis and console port and a method of enabling the same. The method and process of the present invention includes locking the ethernet switch or the router console port (OSI layer 2 or layer 3) of remote network devices and then recovering or turning on the ethernet switch and/or router console port. This is done through the isolation and control of an inside network egress and an outside ingress of the physical console port.

The present invention enables an operator to turn off and secure the console port, allowing for chassis security as well as console port security for unattended devices as well as remote devices. The process also allows the reverse recovery of the port. The process works for devices with single or dual IP stacks. The turning off the console port completely isolates the inside network of the switch and prevents network intrusion or device corruption via the console port. It also prevents unauthorized configuration changes of the device.

Referring now to the FIGURE, the present invention includes a secure ethernet chassis and console port providing a processor capable of turning off an ethernet switch and/or router console port and then selectively recovering or turning on the port.

The present invention may include the following steps:
1. An added graphical user interface (GUI) to code service control configuration for ON/OFF console port
2. Turn off console serial port at CPU (processor) through machine code
3. Normalize the machine code within the CPU to see normal response for turned off console port
4. Add code to POST (Power On Self-Test) to return normal result even if console port is off—i.e., normalize POST testing to normal
5. Add processor code to reverse processor service interrupts when feature is turned off

Step 1 adds an On/Off console command into the Operating System GUI (Linux). Steps 2-4 adds machine code instructions for CPU service interrupts as well as self-test interrupts for normal operation, regardless of the console port state. The last step provides the code to reverse the CPU service interrupts to normal console port operation. This process uses the CPU service interrupts for the console port. The present invention allows for the interrupt to be changed. The present invention normalizes the result on the self-test. The console port is completely dead to the processor when in the off-secured condition.

By following the above listed steps, in the order listed, the device console port (ethernet switch and/or router) can be secured from physical hacking, or tampering. In sum, through code, the reset button is selectively moved between an off-closed condition and an on-open condition. Coding may be used to normalize the Linux kernel.

A method of using the present invention may include the following. An operator implements the systemic code on an associated device via service control. Service control executes code and visually provides indicators to security. As a result, the present invention reduces theft and reduces known points of network penetration. Further, the present invention reduces the number of people able to access and use the network, thereby improving device safety by reducing device theft potential through securing the console port and chassis. Remote devices are secured despite questionable user-enabled physical security.

The present invention may work with ethernet switches—OSI layer 2; routers—OSI layer 3 devices; and OSI layers 4-7 with console ports to secure any device using a console port, including Linux Medical devices, which are subject to this same issue of remote or unattended security.

It should be understood, of course, that the foregoing relates to exemplary embodiments of the invention and that modifications may be made without departing from the spirit and scope of the invention as set forth in the following claims.

What is claimed is:

1. A method of providing security to a computer network coupled to a plurality of remote computing devices, comprising:
providing a service control function for a remote computing device, the service control function configured to move an associated ethernet switch and/or an associated router console port to an off-locked condition.

2. The method of claim 1, further comprising:
instructing a central processor unit associated with the remote computing device, through machine code, to provide self-test interrupts for normal operations regardless of the off-locked condition.

3. The method of claim 1, wherein the off-secured condition turns off a console serial port at a central processor unit associated with the remote computing device.

4. The method of claim 3, further comprising:
instructing, through machine code, a central processor unit associated with the remote computing device to provide a normal result for a Power On Self-Test regardless of the off-locked condition.

5. The method of claim 4, further comprising:
instructing, through machine code, a central processor unit associated with the remote computing device to selectively moving the associated ethernet switch and/or the associated router console port to an on-unlocked condition.

6. The method of claim 1, wherein the off-locked condition controls of an inside network egress and an outside ingress of the physical console port.
